(19) United States
(12) Patent Application Publication
(10) Pub. No.: US 2026/0099203 A1
(43) Pub. Date: Apr. 9, 2026

(54) WEARABLE ELECTRONIC APPARATUS FOR DETERMINING USER STATUS INFORMATION BASED ON USER'S BIOELECTRICAL SIGNAL AND CONTROL METHOD THEREOF

(71) Applicant: Samsung Electronics Co., Ltd., Suwon-si (KR)

(72) Inventors: Hyunjin AHN, Suwon-si (KR); Yoosung KIM, Suwon-si (KR); Eunkyu OH, Suwon-si (KR); Suho LEE, Suwon-si (KR); Daeung JEONG, Suwon-si (KR); Seonho KIM, Suwon-si (KR)

(21) Appl. No.: 19/273,765

(22) Filed: Jul. 18, 2025

(30) Foreign Application Priority Data
Oct. 4, 2024 (KR) 10-2024-0134676
Nov. 13, 2024 (KR) 10-2024-0161366

(51) Int. Cl. G06F 3/01

(52) U.S. Cl. CPC G06F 3/015

(57) ABSTRACT

A wearable electronic apparatus includes: a housing configured to be worn on an ear of a user and including a first housing and a second housing connected to the first housing, memory storing instructions, a first electrode disposed at the first housing and configured to contact a first surface of the ear, a second electrode disposed at the second housing and configured to contact a second surface of the ear, a third electrode disposed at the second housing and configured to contact a mastoid region of the user, and at least one processor, comprising processing circuitry, wherein at least one processor, individually or collectively, is configured to execute the instructions and to cause the wearable electronic apparatus to, while the wearable electronic apparatus is worn by the user, obtain a bioelectrical signal of the user via the first electrode of the first housing, which contacts the first surface of the ear of the user, the second electrode of the second housing, which contacts the second surface of the ear of the user, and the third electrode of the second housing, which contacts the mastoid region of the user.

### CROSS-REFERENCE TO RELATED APPLICATIONS

This application is a continuation of International Application No. PCT/KR2025/008556 designating the United States, filed on Jun. 20, 2025, in the Korean Intellectual Property Receiving Office and claiming priority to Korean Patent Application Nos. 10-2024-0134676, filed on Oct. 4, 2024, and 10-2024-0161366, filed on Nov. 13, 2024, in the Korean Intellectual Property Office, the disclosures of each of which are incorporated by reference herein in their entireties.

### BACKGROUND

### Field

The disclosure relates to a wearable electronic apparatus and a control method thereof, and for example, to a wearable electronic apparatus determining user status information based on a bioelectrical signal of a user, and a control method thereof.

### Description of Related Art

With the advancement in electronic technologies, various types of electronic apparatuses have been developed. In recent years, at a time when a growing number of users pursue mental wellbeing, more wellness electronic apparatuses have been developed.

For example, such wellness electronic apparatuses may be worn by users, measure electroencephalogram (EEG) of the users, and based on the measured EEG, provide various types of information such as a health condition or an emotional state of the users.

The above-descried particulars may be provided as related art aiming for a better understanding of the present disclosure. No assertion or determination is raised as to whether any of the particulars is applicable as prior art associated with the present disclosure.

### SUMMARY

According to an example embodiment, a wearable electronic apparatus includes: a housing configured to be worn on an ear of a user and including a first housing and a second housing connected to the first housing, memory storing instructions, a first electrode disposed at the first housing and configured to contact a first surface of the ear, a second electrode disposed at the second housing and configured to contact a second surface of the ear, a third electrode disposed at the second housing and configured to contact a mastoid region of the user, and at least one processor, comprising processing circuitry, wherein at least one processor, individually or collectively, may be configured to execute the instructions and to cause the wearable electronic apparatus to: while the wearable electronic apparatus is worn by the user, obtain a bioelectrical signal of the user via the first electrode of the first housing, which contacts the first surface of the ear of the user, the second electrode of the second housing, which contacts the second surface of the ear of the user, and the third electrode of the second housing, which contacts the mastoid region of the user.

The housing may further include a connecting element comprising a connector connected to the first housing part and the second housing part, and having elasticity such that the first housing and the second housing and configured to provide a force in a direction toward each other.

The wearable electronic apparatus may be configured to be worn by the user based on the connecting element being folded, and a point at which the connecting element is folded may be adjusted.

A length from the point at which the connecting element is folded to the first housing part may be greater than a length from the point at which the connecting element is folded to the second housing part.

The second housing may include a first surface facing the second surface of the ear, a second surface disposed opposite to the first surface, and a side surface connecting the first surface and the second surface, and a portion of the third electrode may be disposed on the side surface.

An area of the side surface, in which the third electrode is disposed, may be curved to have a different curvature from an area of the side surface, in which the third electrode is not disposed.

Other than the portion of the third electrode, a remainder of the third electrode may be disposed on the first surface or the second surface.

The second housing may have a greater volume than the first housing.

At least one processor, individually or collectively, may be configured to cause the wearable electronic apparatus to obtain at least one of electroencephalogram (EEG), electromyogram (EMG), electrooculogram (EOG), electrodermal activity (EDA) or galvanic skin response (GSR) as the bioelectrical signal.

At least one processor, individually or collectively, may be configured to cause the wearable electronic apparatus to obtain at least one of the EDA or the GSR as the bioelectrical signal by applying a specified voltage to the third electrode, or obtain at least one of the EEG, the EMG or the EOG as the bioelectrical signal without applying the preset voltage to the third electrode.

The wearable electronic apparatus may further include a sensor, and at least one processor, individually or collectively, may be configured to cause the wearable electronic apparatus to, based on identifying that the wearable electronic apparatus is worn by the user through the sensor, obtain the bioelectrical signal via the first electrode, the second electrode, and the third electrode.

At least one processor, individually or collectively, may be configured to cause the wearable electronic apparatus to obtain skin impedance via at least two electrodes among the first electrode, the second electrode, and the third electrode, and based on identifying that the wearable electronic apparatus is worn by the user based on the skin impedance, obtain the bioelectrical signal via the first electrode, the second electrode, and the third electrode.

AT least one processor, individually or collectively, may be configured to cause the wearable electronic apparatus to, based on identifying that the wearable electronic apparatus is worn by the user based on the skin impedance, activate an audio function of the wearable electronic apparatus and obtain the bioelectrical signal via the first electrode, the second electrode, and the third electrode.

The wearable electronic apparatus may further include a communication interface comprising communication circuitry, and at least one processor, individually or collectively, may be configured to cause the wearable electronic apparatus to control the communication interface to transmit the bioelectrical signal to a user electronic device, and receive a guide message corresponding to the bioelectrical signal from the user electronic device through the communication interface.

The wearable electronic apparatus may further include a sensor, and at least one processor, individually or collectively, may be configured to cause the wearable electronic apparatus to obtain motion data of the user through the sensor, and provide a notification to the user based on the motion data.

The first electrode may be one of an active electrode and a reference electrode, the second electrode may be a ground electrode, and the third electrode may be the other of the active electrode and the reference electrode.

The first surface may include a front surface of the ear, and the second surface may include a rear surface of the ear.

### BRIEF DESCRIPTION OF THE DRAWINGS

In description of the drawings, like or similar reference numerals may denote like or similar elements. Further, the above and other aspects, features and advantages of certain embodiments of the present disclosure will be more apparent from the following detailed description, taken in conjunction with the accompanying drawings, in which:

FIG. 1 is a block diagram illustrating an example configuration of an electronic apparatus according to various embodiments;

FIG. 2 is a block diagram illustrating an example configuration of an electronic apparatus according to various embodiments;

FIGS. 3, 4, 5 and 6 are diagrams illustrating various views provided to explain a structure of an electronic apparatus according to various embodiments;

FIG. 7 includes various graphs illustrating an example method for identifying whether a bioelectrical signal is measured reliably according to various embodiments;

FIG. 8 is a flowchart illustrating an example method of measuring a bioelectrical signal according to various embodiments;

FIG. 9 is a circuit diagram illustrating an example operation of circuitry based on whether electrodermal activity is measured according to various embodiments;

FIG. 10 is a block diagram illustrating an example configuration of an electronic system according to various embodiments;

FIG. 11 and FIG. 12 are diagrams illustrating an example guide message according to various embodiments; and

FIG. 13 is a flowchart illustrating an example method of controlling an electronic apparatus according to various embodiments.

### DETAILED DESCRIPTION

The various example embodiments of the present disclosure may be diversely modified. Accordingly, various example embodiments are illustrated in the drawings and are described in greater detail in the detailed description. However, it is to be understood that the present disclosure is not limited to a specific embodiment, but includes all modifications, equivalents, and substitutions without departing from the scope and spirit of the present disclosure. Also, well-known functions or constructions may not be described in detail if they are deemed to obscure the disclosure with unnecessary detail.

The present disclosure provides an electronic apparatus providing various types of user status information based on a bioelectrical signal of the user as well as securing improvement in a comfortable fit of the user, and a control method thereof.

Hereafter, the present disclosure is described in greater detail with reference to the accompanying drawings.

General terms currently widely used are selected as the terms used in various embodiments of the disclosure in consideration of their functions in the disclosure, but may be changed based on the intention of those skilled in the art or a judicial precedent, the emergence of a new technology, or the like. In addition, in some instances, terms may be arbitrarily chosen and may be included in the terms used herein. In this case, the meanings of such terms are described in detail in the disclosure. Therefore, the terms used in the disclosure should be defined based on the meanings thereof and overall details throughout the disclosure rather than simply names thereof.

In the disclosure, expressions such as “have,” “may have,” “include,” or “may include,” and the like are used to indicate the presence of a corresponding feature (e.g., elements such as a numerical value, a function, an operation, or a component and the like), and do not imply exclusion of the presence of additional features.

In the disclosure, it is to be understood that the expression at least one of A and/or B denotes any one of “A”and “B”or “A or B”.

In the disclosure, the expression “1st”, “2nd”, “first”, or “second”, and the like may be used to refer to various types of elements regardless of their order and/or importance, and may be used merely to differentiate one element from another but not intended to limit the elements.

In the disclosure, singular forms include plural forms as well, unless explicitly indicated otherwise. In the disclosure, the term “include” or “composed of” and the like may refer, for example, to the presence of stated features, numbers, steps, operations, elements, components or combinations thereof but do not imply the exclusion of the presence or addition of one or more other features, numbers, steps, operations, elements, components or combinations thereof.

In the disclosure, the term user may refer to a human who uses an electronic apparatus or an apparatus (e.g., an artificial intelligence electronic apparatus) which uses an electronic apparatus.

Hereafter, various example embodiments of the present disclosure are described in greater detail with reference to the accompanying drawings.

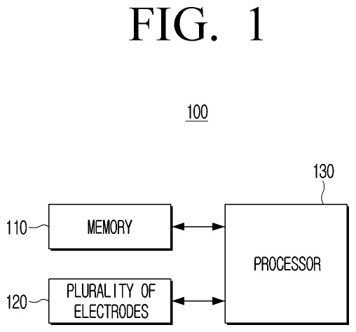

FIG. 1 is a block diagram illustrating an example configuration of an electronic apparatus 100 according to various embodiments.

According to an embodiment, as a wearable electronic apparatus obtaining a bioelectrical signal of the user and determining user status information based on the bioelectrical signal, the electronic apparatus 100 may be implemented in an ear clip form. For example, in the case where the electronic apparatus 100 is implemented in the form of an ear clip, the electronic apparatus 100 may include a housing worn on an ear of the user. The housing may include a first housing part, a second housing part, and a connecting element (e.g., a connector) connecting the first housing part and the second housing part and having elasticity, such that the first housing part and the second housing part may be toward each other. The electronic apparatus 100 may be worn by the user as the connecting element is folded. A length from a point at which the connecting element is folded to the first housing part may be greater than a length from the point at which the connecting element is folded to the second housing part. However, the lengths are not limited thereto, and the point at which the connecting element is folded may be adjusted. Additionally, a length of the connecting element may be adjusted.

According to an embodiment, as the electronic apparatus 100 is worn by the user, one of the first housing part and the second housing part may contact one surface of the ear of the user, and the other of the first housing part and the second housing part may contact the other surface of the ear of the user.

As the electronic apparatus 100 may be implemented in the form of an ear clip as described above, the electronic apparatus 100 may have less volume and may be more lightweight than conventional, and secure a more comfortable fit than conventional. Additionally, the first housing part and the second housing part may be formed in the way that the first housing part and the second housing part surround the ear of the user, and as proper pressure is applied based on the elasticity of the connecting element, may enhance the performance of EEG measurement further than conventional.

Referring to FIG. 1, the electronic apparatus 100 includes memory 110, a plurality of electrodes 200 and a processor (e.g., including processing circuitry) 130.

The memory 110 may refer to hardware that stores information of data in an electricity form or a magnetism form to allow access of the processor 130. To this end, the memory 110 may be implemented as at least one hardware of non-volatile memory, volatile memory, flash memory, hard disk drive (HDD) or solid-state drive (SSD), random access memory (RAM), or read only memory (ROM).

The memory 110 may store at least one instruction required for an operation of the electronic apparatus 100 or the processor 130. Herein, the instruction, as a code unit commanding an operation of the electronic apparatus 100 or the processor 130, may be written in machine language that is a language understandable by a computer. Alternatively, the memory 110 may store a plurality of instructions for performing a specific task of the electronic apparatus 100 or the processor 130, as an instruction set.

The memory 110 may store data that are information of a bit unit or a byte unit capable of representing a character, a number, or an image. For example, the memory 110 may store a neural network model. Herein, the neural network model may be a model that is trained to receive a bioelectrical signal and output user status information.

The memory 110 may be accessed by the processor 130, and the processor 130 may perform reading/recording/correcting/deleting/updating and the like of an instruction, an instruction set, or data.

The plurality of electrodes 120, as an element for measuring electrical characteristics (voltage, current, and impedance) using a living body as a medium, may include equivalent circuitry using a living body as a medium and detect various body features.

For example, the plurality of electrodes 120 may include a first electrode disposed at the first housing part and configured to contact a first surface of the ear of the user, a second electrode disposed at the second housing part and configured to contact a second surface of the ear of the user, and a third electrode disposed at the second housing part and configured to contact a mastoid region of the user. Herein, the second housing part may include a first surface facing the second surface of the ear, a second surface disposed opposite to the first surface, and a side surface connecting the first surface and the second surface, and a portion of the third electrode may be disposed on the side surface. An area of the side surface, in which the third electrode is disposed, may be curved to have a different curvature from an area of the side surface, in which the third electrode is not disposed. A remainder of the third electrode may be disposed on the first surface or the second surface. The second housing part may have a greater volume than the first housing part. Additionally, the mastoid region may refer to a rear portion of the temporal bone that is one of the bones of the skull. The first surface may include a front surface of the ear, and the second surface may include a rear surface of the ear. For example, the first surface may be a front surface area of the ear out of the concha region. That is, the first electrode may contact the front surface on which EEG is measured reliably around the ear, and the third electrode may contact the mastoid region of the user, thereby ensuring an alpha attenuation response test result of about 220% or greater even in the case of a dry electrode. The AAR test may be a test in which a change in an alpha wave band (about 8-about 13 Hz) is observed in the case where the user closes and opens his or her eyes. That is, the electronic apparatus 100 may detect EEG sufficiently even in the case where the electronic apparatus 100 contacts only one of the two ears of the user. However, the electronic apparatus 100 may not be limited thereto, and the second electrode may be included in the connecting element.

According to an embodiment, the first electrode may be one of an active electrode and a reference electrode, the second electrode may be a ground electrode (GND), and the third electrode may be the other of the active electrode and the reference electrode. For example, the first electrode may be a reference electrode, the second electrode may be a ground electrode, and the third electrode may be an active electrode. The reference electrode may be an electrode that is a reference in the case where an electric potential difference is measured, and the active electrode may be an electrode that measures an electric potential with respect to the reference electrode. The ground electrode may be an electrode that is connected to the ground and connected with the case of the electronic apparatus 100 as a reference electrode.

However, the electrodes are not limited thereto, and the third electrode may include a plurality of sub electrodes. Additionally, the processor 130 may also measure a bioelectrical signal in multi channels through the plurality of sub electrodes. Each of the sub electrodes may be an active electrode. The electronic apparatus 100 may include the first electrode and the third electrode only except for the second electrode. The electronic apparatus 100 may only include the first electrode and the third electrode that includes a plurality of sub electrodes except for the second electrode.

According to an embodiment, each of the electrodes may be designed based on a contact surface contacting the user. For example, the first electrode may be implemented in a rounded manner since the first electrode contacts the front surface, the second electrode may be implemented in a planar manner since the shape of the ears of each user varies, and the third electrode may be implemented in a planar manner to contact the mastoid region.

The processor 130 may include various processing circuitry and controls operations of the electronic apparatus 100 entirely. For example, the processor 130 may be connected with each of the elements of the electronic apparatus 100 to control the operations of the electronic apparatus 100 entirely. For example, the processor 130 may be connected to the elements such as memory 110, a plurality of electrodes 120 electrically and/or operatively to control the operations of the electronic apparatus 100. In an embodiment, the operative connection of hardwares of the electronic apparatus 100 may denote establishing a direct connection or an indirect connection among hardwares in a wired manner or in a wireless manner, such that second hardware may be controlled by first hardware among hardwares.

The one or more processors 130 may include one or more of a central processing unit (CPU), a graphics processing unit (GPU), an accelerated processing unit (APU), many integrated core (MIC), a neural processing unit (NPU), a hardware accelerator or a machine learning accelerator. The one or more processors 130 may control one among other elements of the electronic apparatus 100 or any combination thereof, and perform an operation in association with communication or data processing. The one or more processors 130 may execute one or more programs or instructions stored in the memory 110. For example, the one or more processors 130 may perform a method according to an embodiment, by executing one or more instructions stored in the memory 110. Thus, the processor(s) 130 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

In the case where the method according to an embodiment of the disclosure includes a plurality of operations, the plurality of operations may be performed by one processor, or by a plurality of processors. For example, when a first operation, a second operation, and a third operation are performed based on the method according to an embodiment, the first operation, the second operation and the third operation may all be performed by a first processor, or the first operation and the second operation may be performed by the first processor (e.g., a general-purpose processor), while the third operation may be performed by a second processor (e.g., an AI-exclusive processor).

The one or more processors 130 may be implemented as a single core processor including one core, or one or more multicore processors including a plurality of cores (e.g., a homogeneous multi core or a heterogeneous multi core). In the case where the one or more processors 130 are implemented as a multicore processor, each of the plurality of cores included in the multicore processor may include processor internal memory such as cache memory, and on-chip memory, and common cache shared by the plurality of cores may be included in the multicore processor. Additionally, each of the plurality of cores (or part of the plurality of cores) included in the multicore processor may read and perform a program instruction for implementing the method according to an embodiment independently or in the way that all (or part) of the plurality of cores are associated.

In the case where the method according to an embodiment includes a plurality of operations, the plurality of operations may be performed by one of the plurality of cores or performed by the plurality of cores included in the multicore processor. For example, when a first operation, a second operation, and a third operation are performed based on the method according to an embodiment, the first operation, the second operation and the third operation may all be performed by a first core included in the multicore processor, or the first operation and the second operation may be performed by the first core included in the multicore processor, while the third operation may be performed by a second core included in the multicore processor.

In the various example embodiments of the disclosure, the one or more processors 130 may denote a system on a chip (SoC) where one or more processors and other electronic components are integrated, a single core processor, a multicore processor, or a core included in a single core processor or a multicore processor, and herein, the core may be implemented as a CPU, a GPU, an APU, an MIC, an NPU, a hardware accelerator, or a machine learning accelerator, but embodiments thereof may not be limited thereto. Hereafter, the expression processor 130 is used to describe the operations of the electronic apparatus 100 for convenience of description.

According to an embodiment, while a wearable electronic apparatus 100 is worn by the user, the processor 130 may obtain a bioelectrical signal of the user via the first electrode of the first housing part, which contacts the first surface of the ear of the user, the second electrode of the second housing part, which contacts the second surface of the ear of the user, and the third electrode of the second housing part, which contacts the mastoid region of the user.

For example, the processor 130 may obtain at least one of electroencephalogram (EEG), electromyogram (EMG), electrooculogram (EOG), electrodermal activity (EDA) or galvanic skin response (GSR) as a bioelectrical signal. The processor 130, for example, may obtain at least one of the EDA or the GSR as a bioelectrical signal by applying a preset voltage to the third electrode, or obtain at least one of the EEG, the EMG or the EOG as a bioelectrical signal without applying the preset (e.g., specified) voltage to the third electrode. The EEG may include information in which a change in electrical potential from brain cells is recorded, the EMG may include information in which action potentials of muscles are recorded, the EOG may include information in which the contraction or relaxation of the muscles of the eyes are recorded based on an electric potential difference, the EDA may include information in which electrical conductivity of skin is measured, and the GSR may include information in which electrical activity measured through skin is recorded.

However, the bioelectrical signal is not limited thereto, and the processor 130 may obtain various type of bioelectrical signals of the user in any way possible.

According to an embodiment, the electronic apparatus 100 may further include a sensor, and based on identifying that the electronic apparatus 100 is worn by the user through the sensor, the processor 130 may obtain a bioelectrical signal via the first electrode, the second electrode and the third electrode. For example, in the cases where the sensor is an infrared sensor and where it is identified that the electronic apparatus 100 is worn by the user through the infrared sensor, the processor 130 may obtain a bioelectrical signal via the first electrode, the second electrode and the third electrode. However, the sensor may not be limited thereto, and the processor 130 may sense whether the electronic apparatus 100 is worn by the user through various types of sensors. For example, the processor 130 may sense whether the electronic apparatus 100 is worn by the user through a pressure sensor or a temperature sensor. The processor 130 may also sense whether the electronic apparatus 100 is worn by the user through a proximity sensor.

The processor 130 may obtain skin impedance through at least two of the first electrode, the second electrode and the third electrode, and in the case where it is identified that the electronic apparatus 100 is worn by the user based on the skin impedance, the processor 130 may also obtain a bioelectrical signal via the first electrode, the second electrode and the third electrode. The skin impedance may be an index representing electrical resistance of skin. For example, the skin impedance of dry skin may be about 15 kΩ-about 1 MΩ, while the skin impedance of wet skin may be about 1 kΩ.

According to an embodiment, in the case where it is identified that the electronic apparatus 100 is worn by the user based on the skin impedance, the processor 130 may activate an audio function of the electronic apparatus 100 and obtain a bioelectrical signal via the first electrode, the second electrode and the third electrode.

According to an embodiment, in the case where it is identified that the electronic apparatus 100 is worn by the user based on using the sensor and based on using the skin impedance, the processor 130 may activate the audio function and obtain a bioelectrical signal via the first electrode, the second electrode and the third electrode.

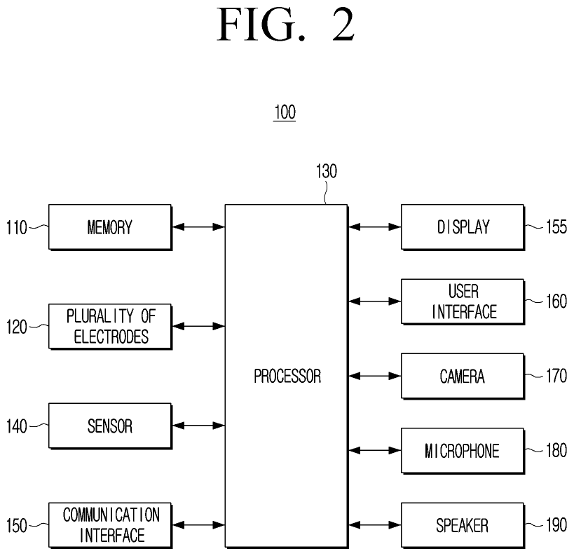

The processor 130 may determine user status information based on the obtained bioelectrical signal. For example, the electronic apparatus may further include a communication interface (e.g., a communication interface 150 of FIG. 2), including various communication circuitry, and the processor 130 may control the communication interface 150 to transmit a bioelectrical signal to a user electronic device (e.g., a smartphone, a laptop, a tablet personal computer (PC), a desktop PC, or a television (TV)) and may receive, from the user electronic device, user status information such as an attention level, a meditation level, and a stress level based on the bioelectrical signal, through the communication interface 150. The processor 130 may also receive a guide message corresponding to the bioelectrical signal from the user electronic device through the communication interface 150. In this case, the user electronic device may obtain the user status information such as an attention level, a meditation level, and a stress level based on the bioelectrical signal, and provide a guide message corresponding to the status information to the electronic apparatus 100.

The electronic apparatus 100 may further include a sensor (e.g., a gyro sensor, an acceleration sensor, and a magnetic field sensor), and the processor 130 may obtain motion data of the user through the sensor, and provide a notification to the user based on the motion data.

The user status information may include at least one of an attention level, a meditation level or a stress level, and the processor 130 may provide a guide message to the user based on the user status information. The attention level may denote a degree to which the user is not distracted by inner thoughts, the meditation level is a degree to which the heart and mind are calm, and the stress level may denote a degree of psychological nervousness changed by a mental stimulus and a physical stimulus. However, the user status information may not be limited thereto, and may further include a different category of information based on the status of the user. For example, the user status information may further include information as to whether the user is drowsy or not.

The processor 130 may determine the user status information by inputting a bioelectrical signal to a neural network model. For example, the processor 130 may obtain information on at least one of an attention level, a meditation level, a stress level, or drowsiness by inputting a bioelectrical signal to a neural network model.

However, the user status information may not be limited thereto, and a neural network model for determining status information of each user may be individually trained. For example, the processor 130 may obtain information on an attention level by inputting a bioelectrical signal and motion data to a first neural network model. Herein, the first neural network model may be a model that is trained based on a feature obtained from power of a frequency band and a shape of a time-domain signal of at least one of EEG, heart rate variability (HRV) or motion data.

The processor 130 may obtain information on a meditation level by inputting a bioelectrical signal and breathing information obtained by the sensor 140 to a second neural network model. The second neural network model may be a model that is trained based on a feature obtained from power of a frequency band and a shape of a time-domain signal of at least one of EEG or breathing information.

The processor 130 may obtain information on a stress level by inputting a bioelectrical signal to a third neural network model. The third neural network model may be a model that is trained based on a feature obtained from power of a frequency band and a shape of a time-domain signal of at least one of EEG, HRV, breathing information or inter-beat interval (IBI).

The processor 130 may obtain information as to whether the user is drowsy by inputting a bioelectrical signal to a fourth neural network model. Herein, the fourth neural network model may be a model that is trained based on a feature obtained from power of a frequency band and a shape of a time-domain signal of at least one of EEG, HRV, or breathing information.

Obtaining the user status information directly by the processor 130 using the neural network models is described above, but obtaining the user status information is not limited thereto. For example, the processor 130 may transmit a bioelectrical signal and motion data to the user electronic device and receive the user status information from the user electronic device. In this case, the user electronic device may also determine the user status information using the neural network models.

Functions in association with the artificial intelligence according to the present disclosure may be operated through the processor 130 and the memory 110.

The processor 130 may be comprised of one processor or a plurality of processors. At this time, the one processor or the plurality of processors may be a general-purpose processor such as a CPU, an application processor (AP) and a digital signal processor (DSP), a graphics-exclusive processor such as a GPU and a vision processing unit (VPU), or an artificial intelligence-exclusive processor such as an NPU.

The processor or the plurality of processors process input data based on predefined operation rules or an artificial intelligence model stored in the memory 110. In the case where the one processor or the plurality of processors are artificial intelligence-exclusive processors, the artificial intelligence-exclusive processors may be designed in a hardware structure specializing in processing of a specific artificial intelligence model. The predefined (e.g., specified) operation rules or the artificial intelligence model may be characterized in that the predefined operation rules or the artificial intelligence model are made based on training.

Being made based on training may denote making predefined operations rules or artificial intelligence models that are configured such that a basic artificial intelligence model may be trained using large numbers of learning data based on a learning algorithm and may achieve desired features (or purposes). Such training may be performed by an apparatus itself in which artificial intelligence according to the present disclosure is performed or performed through a separate server and/or system. Examples of the learning algorithm may include, without limitation, supervised learning, unsupervised learning, semi-supervised learning or reinforcement learning, but not be limited thereto. Herein, supervised learning may denote, without limitation, learning that is performed based on an input and output of training data, unsupervised learning may denote learning that is performed based on an input of training data rather than an output of training data, semi-supervised learning may denote learning that is performed to a model for classification and regression tasks using both of labeled data and non-labeled data, and reinforcement learning may denote learning that is performed to teach software how to make a decision for achieving the best results.

An artificial intelligence model may be comprised of a plurality of neural network layers. Each of the plurality of neural network layers has a plurality of weights, and performs neural network computation based on computation results of a previous layer and computation among the plurality of weights. The plurality of weights possessed by the plurality of neural network layers may be optimized based on training results of the artificial intelligence model. For example, the plurality of weights may be updated such that a loss value or a cost value obtained by/from the artificial intelligence model may be decreased or minimized during a training process. Herein, the loss value may be a difference between results predicted by the model and an actual correct answer and may be used as a target function that is a target of minimization/reduction. For example, cross entropy loss may be used for a classification task, and mean square error may be used for regression analysis. The cost value may be a total cost required to train a model and may include a cost of data collection, labeling, computing resources and the like, and the factors may all affect a final cost of the model.

An artificial neural network may include, for example, and without limitation, a deep neural network (DNN), and for example, may include a convolutional neural network (CNN), a deep neural network (DNN), a recurrent neural network (RNN), a restricted boltzmann machine (RBM), a deep belief network (DBN), a bidirectional recurrent deep neural network (BRDNN), a generative adversarial network (GAN), or a deep Q-network, but not be limited thereto.

FIG. 2 is a block diagram illustrating an example configuration of an electronic apparatus 100 according to various embodiments. The electronic apparatus 100 may include memory 110, a plurality of electrodes 120 and a processor (e.g., including processing circuitry) 130 along the lines described above. Referring to FIG. 2, the electronic apparatus 100 may further include a sensor 140, a communication interface (e.g., including communication circuitry) 150, a display 155, a user interface (e.g., including circuitry) 160, a camera 170, a microphone 180, and a speaker 190. Among the elements illustrated in FIG. 2, detailed description of those described with reference to FIG. 1 may not be repeated here.

The sensor 140, as an element for identifying whether the electronic apparatus 100 is worn by the user, may be implemented as a biometric sensor, a photoresistor, a temperature sensor, and a hotoplethysmography (PPG) sensor.

For example, the biometric sensor may be a sensor that radiates light to the skin of the user and collects absorbed, scattered or reflected light at least partially. For example, the processor 130 may identify whether the electronic apparatus 100 is worn by the user, by radiating light to the outer ear through the biometric sensor and collecting light by the biometric sensor.

An emitter of the biometric sensor may radiate light of various bands and be implemented as a device of a light emitting diode (LED), a laser, a vertical cavity surface emitting laser (VCSEL), and a receiver of the biometric sensor may collect reflected and transmitted light at least partially out of the light radiated from the emitter, may provide a value converted through an analog to digital converter (ADC) to the memory 110 or a sensor buffer, and may be implemented as a photodiode (PD), or a complementary metal oxide semiconductor (CMOS) image sensor. The receiver may include a filter for receiving light of a specific band or for filtering out light outside the specific band.

The biometric sensor may further include a sensor controller such as integrated circuit (IC) and analog front-end (AFE), and the sensor controller may control the emitter and the receiver, process received data and provide the processed data to the memory 110 or the processor 130.

However, the biometric sensor may not be limited thereto, and may use sound waves rather than light or use both of the sound waves and the light. The biometric sensor may include a PPG sensor detecting pulse waves with light, and also measure a heart rate (HR), heart rate variability (HRV), blood oxygen (SpO) and blood pressure. Alternatively, the biometric sensor may include a biomarker sensor detecting a specific material or substance in the body. A biomarker may be an index indicating a change in the body such as cells, blood vessels, proteins, deoxyribo nucleic acid (DNA), ribo nucleic acid (RNA), and metabolites in the body, and the biomarker sensor may measure blood sugar, alcohol, advanced glycation end-products (AGEs), and antioxidants.

The photoresistor may include a sensor sensing brightness of external light. The processor 130 may also identify whether the electronic apparatus 100 is worn by the user, based on brightness of external light, received from the photoresistor.

The temperature sensor may be a sensor that measures temperature of a living body or a component. The temperature sensor may be implemented as a contact type temperature sensor or a non-contact type temperature sensor and may provide a measured temperature value to the memory 110 or the processor 130. The processor 130 may also identify whether the electronic apparatus 100 is worn by the user based on the measured temperature value of the temperature sensor. The processor 130 may modify skin temperature or body temperature or identify a situation based on the measured temperature value of the temperature sensor.

The PPG sensor may be a sensor for measuring a change in the blood flow of blood vessels around the skin of the user. The processor 130 may obtain breathing information of the user based on the PPG sensor. Inhalation of the user is associated with a faster heartbeat, while exhalation of the user is associated with a slower heartbeat, and the processor 130 may obtain breathing information from data that are obtained from the PPG sensor, based on a relationship between breathing and a heart rate.

The sensor 140 may include an element for obtaining status information of the electronic apparatus 100. For example, the sensor 140 may further include at least one of a gyro sensor, an acceleration sensor, and a magnetic field sensor. The processor 130 may obtain motion data of the user based on the status information of the electronic apparatus 100, obtained through the sensor 140.

As a sensor for sensing a rotation angle of the electronic apparatus 100, the gyro sensor may measure a change in a direction of an object based on the feature that the gyro sensor always maintains a certain direction set for the first time, with high accuracy, regardless of rotation of the Earth. The gyro sensor may also be referred to as a gyroscope, and may be implemented based on a mechanical method or an optical method in which light is used.

The gyro sensor may measure angular velocity. The angular velocity may denote an angle of rotation per time, and a measurement theory of the gyro sensor is described as follows. For example, in a horizontal state (still state), angular velocity is 0° /s, and then in the case where the object tilts by 50° while the object moves for 10 seconds, average angular velocity for 10 seconds is 5° /s. In the case where the tilt angle of 50 ° is maintained in the still state, angular velocity is 0° /s. During the process, the angular velocity is changed from 0 to 5 and back to 0, and the angle is increased from 0 ° to 50 °. To obtain an angle from angular velocity, integral calculus needs to be performed on entire time. Since the gyro sensor measures angular velocity as described above, a tilt angle may be calculated by performing integral calculus of the angular velocity for entire time. However, errors of the gyro sensor may be caused under the influence of temperature, and since the errors are accumulated during the integral calculus process, a final value may be drifted. Accordingly, the electronic apparatus 100 may be further provided with a temperature sensor, and may compensate the errors of the gyro sensor using the temperature sensor.

The acceleration sensor, as a sensor measuring acceleration of the electronic apparatus 100 or intensity of a shock, may also be referred to as an accelerometer. The acceleration sensor may sense acceleration, vibrations, and dynamic force of a shock, and based on a detection method, may be implemented as an inertia-type acceleration sensor, a gyro-type acceleration sensor, and a silicon semiconductor-type acceleration sensor. The inertia-type acceleration sensor may be based on a method of measuring inertial acceleration, the gyro-type acceleration sensor may be based on a method of sensing angular velocity acting on an inertial frame, and the silicon semiconductor-type acceleration sensor may be based on a method of using a silicon semiconductor sensing acceleration and converting the acceleration into an electrical signal. For example, the acceleration sensor, as a sensor sensing a tilt degree of the electronic apparatus 100 using gravitational acceleration, may be ordinarily comprised of two or three-axis fluxgate.

The magnetic field sensor may ordinarily denote a sensor measuring intensity and a direction of terrestrial magnetism, but may broadly include a sensor measuring intensity of magnetization possessed by an object and may also be referred to as a magnetometer. The magnetic field sensor may be implemented in the way that a magnet is hung horizontally in a magnetic field to measure a direction in which the magnet is moved, or in the way that a coil is rotated in a magnetic field to measure induced electromotive force occurring in the coil and measure intensity of the magnetic field.

For example, as a sort of magnetic field sensor, a geomagnetic sensor measuring intensity of terrestrial magnetism may be implemented as a fluxgate geomagnetic sensor detecting geomagnetism ordinarily using fluxgate. The fluxgate geomagnetic sensor denotes a device that uses a highly permeable material such as permalloy as a magnetic core, applies an excited magnetic field through a driving coil wound around the magnetic core, and measures a secondary harmonics element proportional to an external magnetic field that occurs based on magnetic saturation and non-linear magnetic properties of the magnetic core to measure a size and direction of an external magnetic field. As the size and direction of the external magnetic field are measured, a current meridian angle may be detected, and accordingly, a rotation degree may be measured. The geomagnetic sensor may be comprised of two-axis fluxgate or three-axis fluxgate. A two-axis fluxgate sensor, e.g., a two-axis sensor, denotes a sensor comprised of X-axis fluxgate and Y-axis fluxgate that are orthogonal to each other, and a three-axis fluxgate sensor, e.g., a three-axis sensor, denotes a sensor in which Z-axis fluxgate is added to X-axis fluxgate and Y-axis fluxgate.

The above-described geomagnetic sensor and acceleration sensor may be used to obtain status information of the electronic apparatus 100. For example, the status information of the electronic apparatus 100 may be expressed as a pitch angle, a roll angle, or a meridian angle (yaw angle).

The meridian angle (yaw angle) may denote an angle that is changed on a horizontal surface in a left-right direction, and as the meridian angle is calculated, a direction faced by the electronic apparatus 100 may be found. For example, in the case where a geomagnetic sensor is used, the meridian angle may be measured based on Formula 1 described hereafter.

ψ=arctan(sinψ/cosψ) [Formula 1]

Formula 1 described above is provided merely as an example for a better understanding, and the disclosure is not limited thereto. For example, Formula 1 described above may be modified, applied or expanded in various different ways.

Herein, ψ denotes a meridian angle, and cosψ and sinψ may denote an X-axis and Y-axis flux gate output value.

The roll angle may denote an angle at which a horizontal surface tilts left and right, and as the roll angle is calculated, a left-side or right-side gradient of the electronic apparatus 100 may be found. The pitch angle may denote an angle at which a horizontal surface tilts up and down, and as the pitch angle is calculated, a gradient angle at which the electronic apparatus 100 tilts upwards or downwards may be found. For example, in the case where the acceleration sensor is used, the roll angle and the pitch angle may be measured based Formula 2 described hereafter.

φ=arcsin(ay/g)

θ=arcsin(ax/g) [Formula 2]

Formula 2 described above is provided merely as an example for a better understanding, and the disclosure is not limited thereto. For example, Formula 2 described above may be modified, applied or expanded in various different ways.

g denotes gravitational acceleration, φ denotes a roll angle, θ denotes a pitch angle, ax denotes an X-axis acceleration sensor output value, and ay denotes a Y-axis acceleration sensor output value.

The sensor 140 including at least one of a gyro sensor, an acceleration sensor, a magnetic field sensor, or a sound sensor is described above for convenience of description. However, the sensor 140 is not limited thereto, and any sensor may be used as the sensor 140 as long as the sensor obtains status information of the electronic apparatus 100.

The communication interface 150 is an element including various communication circuitry for performing communication with various types of external apparatuses based on various communication methods. For example, the electronic apparatus 100 may perform communication with a user electronic device through the communication interface 150.

The communication interface 150 may include a Wi-Fi module, a Bluetooth module, an infrared communication module, and a wireless communication module. Herein, each communication module may be implemented in the form of at least one hardware chip.

The Wi-Fi module and the Bluetooth module may perform communication respectively based on a Wi-Fi method and a Bluetooth method. In the case where the WiFi module or the Bluetooth module is used, various types of connection information such as a service set identifier (SSID), a session key and the like may be first transmitted and received, and are used to perform communication connection and then transmit and receive various types of information. The infrared communication module performs communication based on an infrared Data Association (IrDA) communication technology which transmits data wirelessly over a short distance using infrared rays between optical light and millimeter waves.

The wireless communication module may include at least communication chip that performs communication based on various wireless communication standards such as zigbee, third generation (3G), 3rd generation partnership project (3GPP), long term evolution (LTE), LTE advanced (LTE-A), fourth generation (4G), and fifth generation (5G).

The communication interface 150 may include a wired communication interface such as a high definition multimedia interface (HDMI), display port (DP), Thunderbolt, universal serial bus (USB), red green blue (RGB), D-subminiature (D-SUB), and digital visual interface (DVI).

The communication interface 150 may also include at least one among wired communication modules that perform communication using a local area network (LAN) module, an Ethernet module, or pair cables, coaxial cables, or fiber optic cables.

The display 155, as an element displaying an image, may be implemented as various types of displays such as, for example, and without limitation, a liquid crystal display (LCD), an organic light emitting diode (OLED) display, and a plasma display panel (PDP). In the display 155, driving circuitry implementable in the form of an a-si thin film transistor (TFT), a low temperature poly silicon (LTPS) TFT, an organic TFT (OTFT), or the like, and a backlight unit may be included together. The display 155 may be implemented as a touch screen coupled with a touch sensor, a flexible display, or a three-dimensional (3D) display.

The user interface 160 may include various interface circuitry and may be implemented as a button, a touch pad, a mouse, and a keyboard or may be implemented as a touch screen capable of performing a display function and a manipulation input function together. The button may be various types of buttons such as a mechanical button, a touch pad, or a wheel and the like that is formed in any area of the front, side and rear of the exterior of the main body of the electronic apparatus 100.

The camera 170 is an element for capturing a still image or a moving image. The camera 170 may capture a still image at a specific time point, but may capture a still image continuously.

The camera 170 includes a lens, a shutter, an aperture, a solid-state imaging device, an analog front end (AFE) and a timing generator (TG). The shutter adjusts time taken for light reflected from a subject to come into the camera 170, and the aperture adjusts an amount of light input to the lens by mechanically increasing or decreasing a size of an opening into which light comes. In the case where light reflected from a subject is accumulated as photocharges, the solid-state imaging device outputs an image formed by the photocharges as an electrical signal. The TG outputs a timing signal for reading out pixel data of the solid-state imaging device, and the AFE samples and digitizes an electrical signal output from the solid-state imaging device.

The microphone 180 is an element for receiving a sound and converting the sound into an audio signal. The microphone 180 may be connected with the processor 130 electrically, and may receive a sound under the control of the processor 130.

For example, the microphone 180 may be formed in the way that the microphone is integrated in directions of an upper side, a front surface, or a side surface of the electronic apparatus 100. Alternatively, the microphone 180 may be provided in a remote controller separate from the electronic apparatus 100. In this case, the remote controller may receive a sound through the microphone 180, and provide the received sound to the electronic apparatus 100.

The microphone 180 may include various types of elements such as a microphone collecting a sound in an analog form, amplification circuitry amplifying the collected sound, and analog/digital (A/D) converter circuitry sampling the amplified sound and converting the amplified sound into a digital signal, and filter circuitry removing noise components from the converted digital signal.

The microphone 180 may be implemented in the form of a sound sensor, but may be implemented in any form as long as the microphone 180 collects a sound.

The speaker 190 is an element for outputting various types of notification sounds or voice messages as well as various types of audio data processed by the processor 130.

Since the electronic apparatus 100 may be implemented in an ear clip form as described above, the electronic apparatus 100 may have less volume, may be smaller and more lightweight and may have a more comfortable fit than conventional. The first housing part and the second housing part may be formed in the way that the first housing part and the second housing part surround the ear of the user, and as proper pressure is applied because of elasticity of the connecting element, may enhance performance of EEG measurement further than conventional.

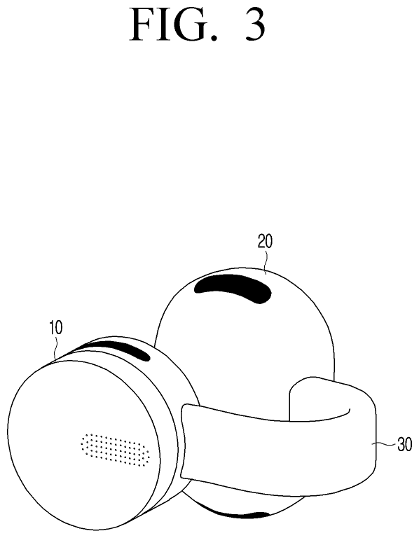

An operation of the electronic apparatus 100 is described in greater detail with reference to FIGS. 3-12. In FIGS. 3-12, an example embodiment is described for convenience of description. However, the example embodiment in FIGS. 3-12 may be implemented in a combined state in any way possible.

FIGS. 3, 4, 5 and 6 are diagrams including various views illustrating an example structure of an electronic apparatus 100 according to various embodiments. For example, FIGS. 3 to 6 are views showing the electronic apparatus 100 seen in different directions, in the state where the electronic apparatus 100 is worn on an ear.

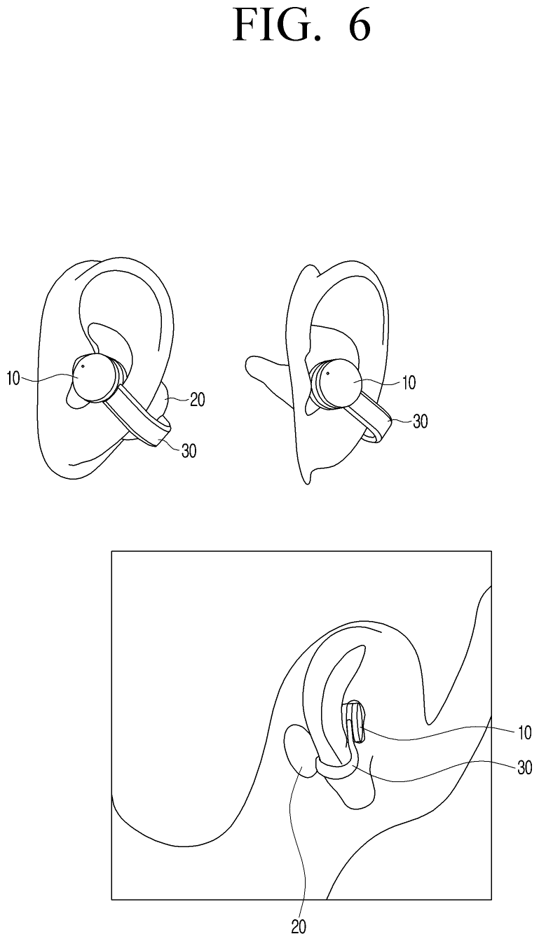

The electronic apparatus 100, as illustrated in FIG. 3, may include a first housing part (e.g., first housing) 10, a second housing part (e.g., second housing) 20 and a connecting element (e.g., a connector) 30. As illustrated in FIG. 6, the first housing part 10, like a conventional earphone, may be inserted into the ear at least partially, while the second housing part 20 may contact a rear surface of the ear at least partially, and as the first housing part 10 and the second housing part 20 are toward each other because of elasticity of the connecting element 30, the electronic apparatus 100 may be worn on the ear.

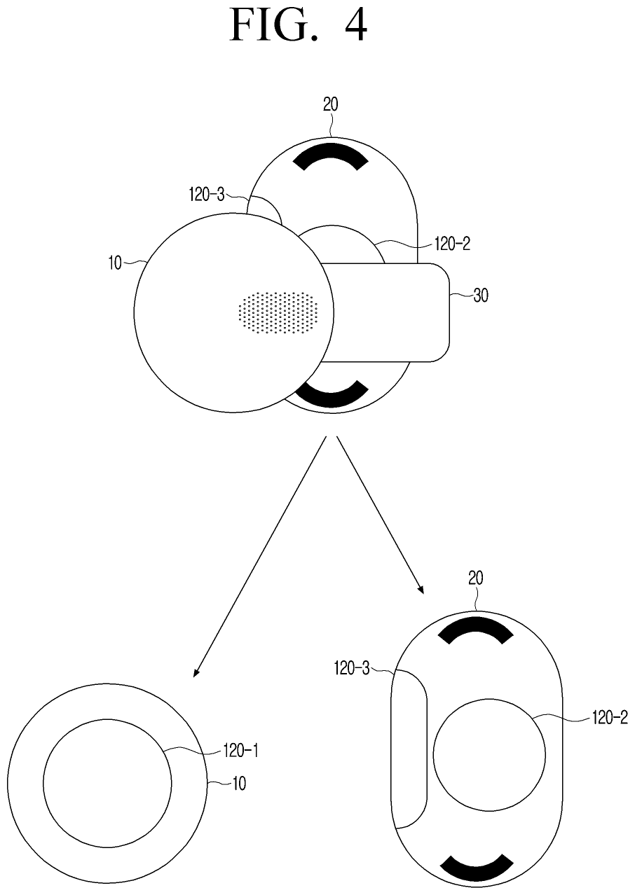

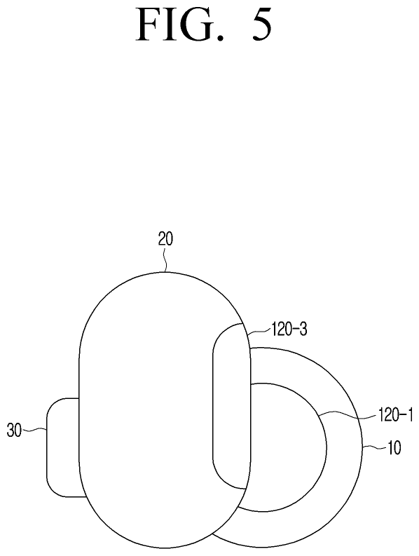

As illustrated in FIGS. 4 and 5, the first housing part 10 may include a first electrode 120-1, and the second housing part 20 may include a second electrode 120-2 and a third electrode 120-3. At the lower end of FIG. 4, the first housing part 10 and the second housing part 20 are illustrated separately for a better understanding of the structure of the electronic apparatus 100. As shown at the left lower end of FIG. 4, the first housing part 10 may include the first electrode 120-1, and the first electrode 120-1 may contact a first surface of the ear of the user. As shown at the right lower end of FIG. 4, the second housing part 20 may include the second electrode 120-2 and the third electrode 120-3, and the second electrode 120-2 may contact a second surface of the ear of the user, while the third electrode 120-3 may contact a mastoid region of the user. The state in which the electronic apparatus 100 is worn is described in greater detail with reference to FIG. 6.

Additionally, the first housing part 10 may further include an antenna, a photoresistor, a user interface 160, a microphone 180, and a speaker 190, while the second housing part 20 may further include memory 110, a processor 130, a biometric sensor, a temperature sensor, a PPG sensor, a gyro sensor, an acceleration sensor, a magnetic field sensor, a barometer, a communication interface 150, a microphone 180, a battery, and an analog front end (AFE), and the connecting element 30 may include a flexible printed circuit board (FPCB).

The user interface 160 may include a button or a crown for a physical manipulation, and sense motions such as a press, a touch, an approach or a rotation. Additionally, the user interface 160 may also include a sensor capable of sensing a touch, a pressure, and a gesture.

The barometer may be a sensor that senses air pressure. The processor 130 may obtain altitude information through the barometer.

The FPCB may be an electric circuit board exhibiting flexible characteristics. The FPCB may electrically connect the elements (e.g., a first electrode, a second electrode, a third electrode, memory 110, a processor 130, a microphone 180, a speaker 190 and the like) in each of the first housing part 10 and the second housing part 20.

The first electrode 120-1 may contact the front surface of the ear of the user, while the second electrode 120-2 may contact the rear surface of the ear of the user, and the third electrode 120-3 may contact the mastoid region of the user. In an embodiment, the first electrode 120-1 may be a reference electrode, the second electrode 120-2 may be a ground electrode, and the third electrode 120-3 may be an active electrode. Herein, the mastoid region may be a rear portion of the temporal bone that is one of the bones of the skull, and the reference electrode may be an electrode that is a reference in the case where an electric potential difference is measured, and the active electrode may be an electrode that measures an electric potential with reference to the reference electrode. The ground electrode may be an electrode that is connected to the ground and connected to the case of the electronic apparatus 100 as a reference electrode.

Each of the electrodes may include an interface for measuring electrical characteristics (voltage, current, and impedance) using a living body as a medium, and may include equivalent circuitry using a living body as a medium and detect various body features. For example, the processor 130 may measure an electrocardiogram (ECG) of the heart via the third electrode 120-3 in contact with a finger of the user rather than the first electrode 120-1 and the mastoid region. Since the electrocardiogram is measured through the front and rear of the heart, the user needs to space the third electrode 120-3 from the mastoid region and touch the electrode 120-3 with a finger. The processor 130 may measure the EDA using the first electrode 120-1 and the third electrode 120-3. For example, the processor 130 may measure the EDA by supplying power to the third electrode 120-3. The EDA may include measurement in association with skin's electrical response such as skin conductance, GSR, electrodermal response (EDR), and psychogalvanic reflex (PRG). Herein, the skin conductance may include information on measured electrical conductivity of skin, the EDR may include a change in the electrical characteristics of skin as sweat glands become more active, and the PRG may include a physiological response to a mental stimulus or an emotional stimulus that reduces the electrical resistance of skin. However, the EDA is not limited thereto, and the processor 130 may obtain various bioelectrical signals using the plurality of electrodes 120 in any way possible.

The AFE may amplify and filter out a signal from each electrode. Additionally, the AFE may convert the signal into a digital signal.

Among the elements included in each housing, remaining elements except for the electrodes may also be included in another housing rather than the housing described with reference to FIGS. 4-6.

FIG. 6 includes various viees provided to explain a structure of an electronic apparatus 100 according to various embodiments. For example, FIG. 6 includes views showing the electronic apparatus 100 seen in different directions, in the state where the electronic apparatus 100 is worn on an ear. As illustrated at the upper end of FIG. 6, the first electrode 120-1 included in the first housing part 10 may contact the front surface of the ear of the user. In particular, the first electrode 120-1 may contact the concha region on the front surface of the ear of the user. The second electrode 120-2 included in the second housing part 20 may contact the rear surface of the ear of the user. As illustrated at the lower end of FIG. 6, the third electrode 120-3 included in the second housing part 20 may contact the mastoid region of the user. That is, the second electrode 120-2 may be provided in an area of the second housing part 20, which contacts the rear surface of the ear of the user, and the third electrode 120-3 may be provided in an area of the second housing part 20, which contacts the mastoid region of the user.

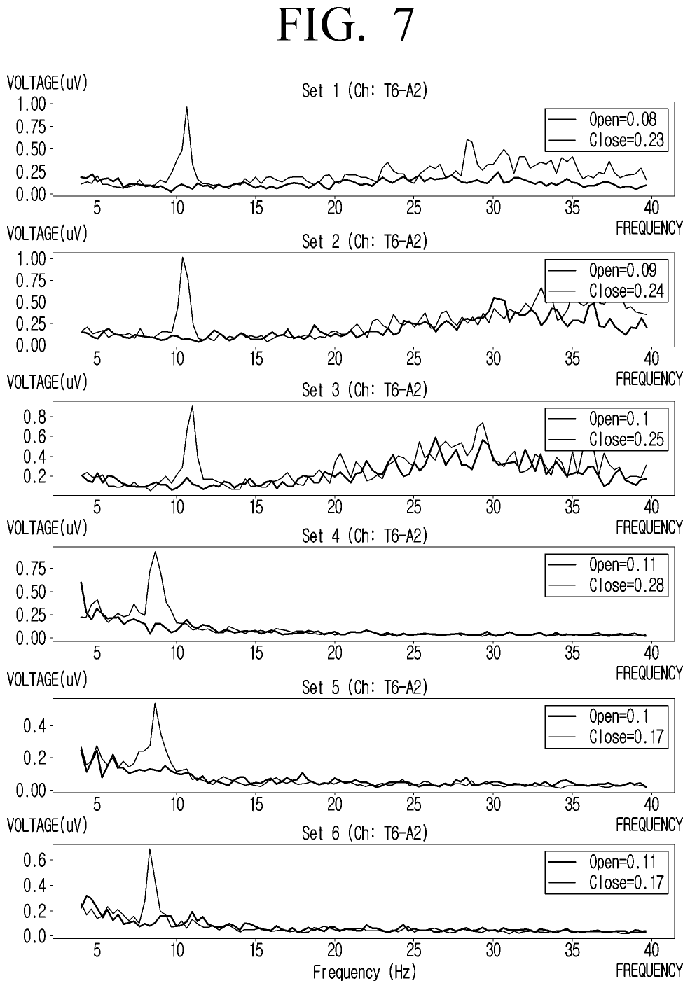

FIG. 7 includes various graphs illustrating an example method for identifying whether a bioelectrical signal is measured reliably according to various embodiments. In FIG. 7, an x-axis denotes a frequency (Hz), and a y-axis denotes voltage (uV).

The processor 130 may identify whether a bioelectrical signal is measured reliably based on an alpha attenuation response (AAR) test. The AAR test, as illustrated in FIG. 7, involves observing a change in an alpha wave band (8-13 Hz) in the case where the user closes (opens) his or her eyes and opens (closes) his or her eyes, and the processor 130 may identify that EEG is measured reliably in the case where the frequency bounces when the user closes (opens) his or her eyes.

A measurement protocol proceeded for a total of 100 seconds, the first 10 seconds and last 10 seconds were removed, the user repeated opening and closing his or her eyes per 20 seconds, and frequencies in an average alpha wave band (about 8-about 13 Hz) of six sessions bounced by about 227% as illustrated in FIG. 7, and accordingly, the electronic apparatus 100 measured EEG normally.

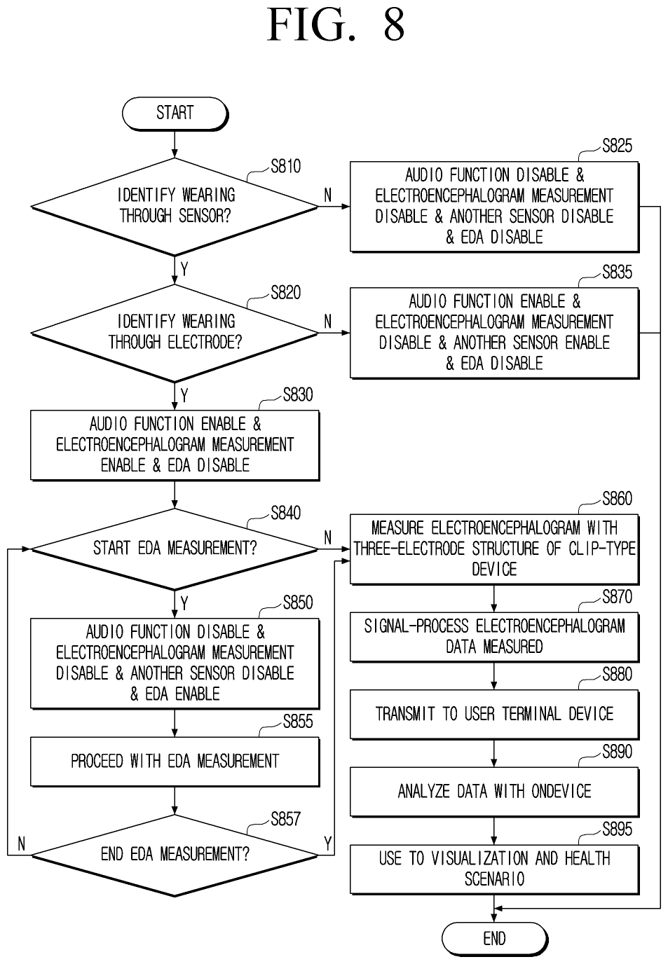

FIG. 8 is a flowchart illustrating an example method of measuring a bioelectrical signal according to various embodiments.

In the example embodiments described hereafter, each of the operations may be performed sequentially, but not necessarily performed sequentially. For example, the order of each of the operations may be changed, and at least two of the operations may be performed in parallel.

According to an embodiment, it may be understood that S810 to S895 are performed by a processor (e.g., a processor 130 of FIG. 1 and/or FIG. 2) of an electronic apparatus (e.g., an electronic apparatus 100 of FIG. 1 and/or FIG. 2).

According to an embodiment, the processor 130 may identify whether the electronic apparatus 100 is worn by the user through the sensor 140 (S810). For example, the processor 130 may identify whether the electronic apparatus 100 is worn by the user through an infrared sensor.

According to an embodiment, when identifying that the electronic apparatus 100 is not worn by the user through the sensor 140, the processor 130 may inactivate/disable all of an audio function, measurement of EEG, another sensor, and EDA (S825).

According to an embodiment, when identifying that the electronic apparatus 100 is worn by the user through the sensor 140, the processor 130 may identify whether the electronic apparatus 100 is worn by the user via the plurality of electrodes 120 (S820). For example, the processor 130 may measure skin impedance via the plurality of electrodes 120, and in the case where the skin impedance is greater than or equal to a threshold value, may identify that the electronic apparatus 100 is worn by the user, and in the case where the skin impedance is less than the threshold value, may identify that the electronic apparatus 100 is not worn by the user.

According to an embodiment, when identifying that the electronic apparatus 100 is not worn by the user via the plurality of electrodes 120, the processor 130 may activate/enable the audio function and another sensor, and inactivate/disable the measurement of EEG and the EDA (S825).

According to an embodiment, when identifying that the electronic apparatus 100 is worn by the user via the plurality of electrodes 120, the processor 130 may activate/enable the audio function and the measurement of EEG, inactivate/disable measurement of the EDA (S830), and start to measure the EDA (S840). For example, when receiving, from the user, an instruction for measuring the EDA, the processor 130 may start to measure the EDA, and when not receiving, from the user, the instruction for measuring the EDA, the processor 130 may start to measure EEG.

According to an embodiment, when starting to measure the EDA, the processor 130 may inactivate/disable the audio function, the measurement of EEG, and another sensor, activate/enable the EDA (S850), and proceed with the measurement of the EDA (S855).

For example, the processor 130 may start measurement in association with skin's electrical response such as skin conductance, GSR, EDR, and PRG by starting to measure the EDA.

The processor 130 may identify whether the measurement of the EDA ends (S857), and in the case where the measurement of the EDA does not end, may measure the EDA (S840). In the case where the measurement of the EDA ends, the processor 130 may measure EEG via the plurality of electrodes 120 (S860), and signal-process EEG data measured (S870). For example, the processor 130 may apply a low pass filter or a band pass filter for removing noises of about 50 Hz and about 60 Hz corresponding to electricity noise to the EEG data. In the case where a plurality of signals is measured via the plurality of sub electrodes included in the third electrode 120-3, the processor 130 may select a signal of small contact impedance or a signal of a low signal to noise ratio (SNR).

According to an embodiment, the processor 130 may also output an audio during the measurement of EEG.

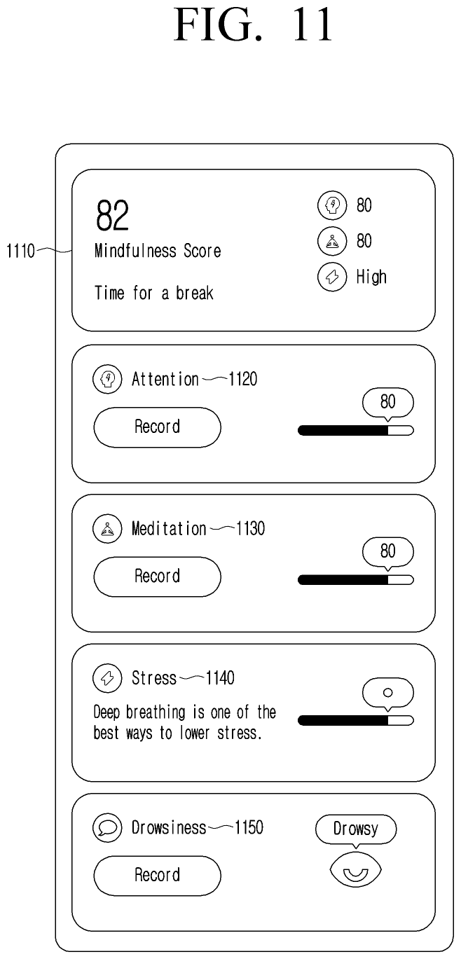

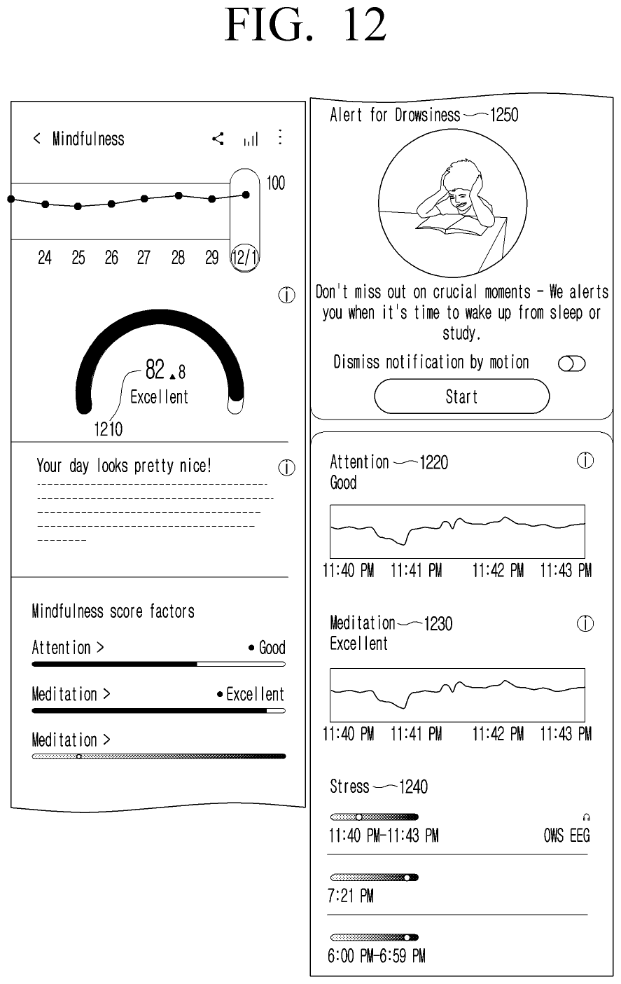

According to an embodiment, the processor 130 may transmit the signal-processed EEG data to the user electronic device (S880), and the user electronic device may analyze the received data (S890) and use the same for visualization and a health scenario (S895). The visualization and the health scenario are described in greater detail below with reference to FIG. 11 and FIG. 12.

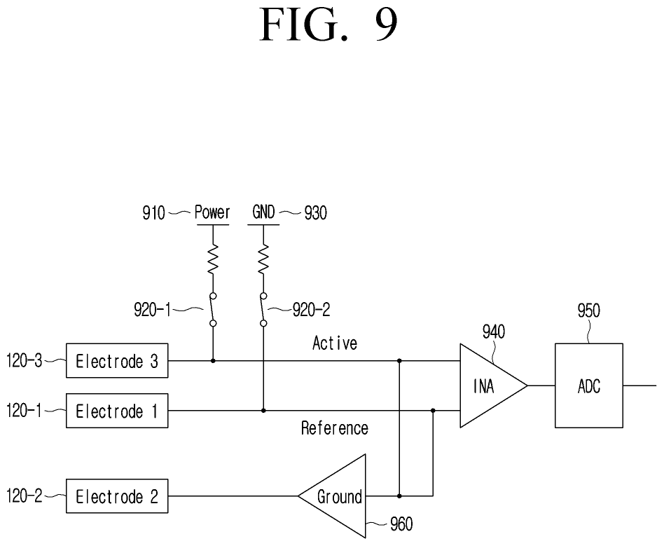

FIG. 9 is a circuit diagram illustrating an exmaple operation of circuitry based on whether electrodermal activity is measured according to various embodiments.

According to an embodiment, the EDA may include skin conductance, GSR, EDR, and PRG, and the processor 130 may supply power to the third electrode 120-3 at a time of measurement of the EDA. The processor 130 may not supply power to the third electrode 120-3 at a time of measurement of EEG, EMG and EOG.

For example, in the case where the EDA is measured as illustrated in FIG. 9, the processor 130 may short-circuit a first switch 920-1 connecting power 910 and the third electrode 120-3, and a second switch 920-2 connecting ground (GND) 930 and the first electrode 120-1. Signals measured from the first electrode 120-1 and the third electrode 120-3 may be differenced through an instrumentation amplifier (INA) 940, and converted into digital signals through an analog-to-digital converter (ADC) 950, such that the processor 130 may measure the EDA based on the digital signals.

According to an embodiment, in the case where the measurement of the EDA ends, the processor 130 may open the first switch 920-1 connecting the power 910 and the third electrode 120-3, and the second switch 920-2 connecting the ground 930 and the first electrode 120-1. Additionally, a preset voltage may be supplied to the second electrode 120-2 through a ground block 960 of FIG. 9. The ground block 960 may be an element supplying a reference voltage, and for example, in the case where an IC chip including the ground block 960 operates at about 1.8 V, the ground block 960 may supply about 0.9 V, and the IC chip may measure a voltage range of −0.9 V to +0.9 V with respect to about 0.9 V. The signals measured from the first electrode 120-1 and the third electrode 120-3 may be differenced through the instrumentation amplifier 940 and converted into digital signals through the analog-to-digital converter (ADC) 950, and the processor 130 may measure EEG, EMG, and EOG based on the digital signals.

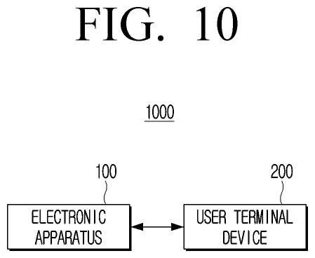

FIG. 10 is a block diagram illustrating an example configuration of an electronic system 1000 according to various embodiments.

The electronic system 100, as illustrated in FIG. 10, may include an electronic apparatus 100 and a user electronic device 200.

According to an embodiment, the electronic apparatus 100 may transmit a bioelectrical signal of the user to the user electronic device 200 through a communication interface 150. The electronic apparatus 100 may transmit a bioelectrical signal at preset time intervals. The electronic apparatus 100 may store bioelectrical signals of a preset time interval, and in the case where an amount of change in the bioelectrical signals is greater than or equal to a preset value, the electronic apparatus 100 may transmit a bioelectrical signal to the user electronic device 200 through the communication interface 150, and in the case where an amount of change in the bioelectrical signals is less than the present value, the electronic apparatus 100 may not transmit a bioelectrical signal to the user electronic device 200.

According to an embodiment, the user electronic device 200 may determine user status information based on the bioelectrical signal, and display the user status information. For example, the user electronic device 200 may display user status information including at least one of an attention level, a meditation level, and a stress level. The user electronic device 200 may also provide a guide message to the user based on the user status information.

The user electronic device 200 may transmit the user status information to the electronic apparatus 100 through the communication interface 150. The electronic apparatus 100 may provide a guide message based on the user status information. For example, the electronic apparatus 100 may provide a notification, when identifying that the user is drowsy based on the user status information.

FIG. 11 and FIG. 12 are diagrams illustrating examples of a guide message according to various embodiments.

According to an embodiment, the user electronic device may provide a guide message based on user status information. For example, the user electronic device, as illustrated in FIG. 11, may provide a final score 1110 calculated as a score based on a collection of the user status information and a detailed message about status information of each user. The user status information may include an attention level 1120, a meditation level 1130, a stress level 1140, or drowsiness 1150.

According to an embodiment, in the case where each item of FIG. 11 is selected, the user electronic device may also provide further details of the touched item as illustrated in FIG. 12. For example, in the case where the final score 1110 of FIG. 11 is selected, the user electronic device may provide a final score 1210 for each date, a message based on the final score, and a summary of status information of each user. Alternatively, in the case where the attention level 1120 of FIG. 11 is selected, the user electronic device may provide an attention level 1220 for each time slot, in the case where the meditation level 1130 of FIG. 11 is selected, the user electronic device may provide a meditation level 1230 for each time slot, and in the case where the stress level 1140 of FIG. 11 is selected, the user electronic device may provide a stress level 1240 for specific time.

The user electronic device may also provide an alarm message based on the user status information. For example, the user electronic device may also provide an alarm message 1250 as shown in FIG. 12, based on whether the user is drowsy 1150 in FIG. 11. The user electronic device may transmit the alarm message to the electronic apparatus 100 based on whether the user is drowsy 1150 in FIG. 11, and the electronic apparatus 100 may provide the alarm message to the user as a sound or vibrations.

Providing an alarm message based on whether the user is drowsy is described above, but is not limited thereto. For example, the user electronic device may sense whether there is a seizure, and may provide an alarm message.

In some cases, the electronic apparatus 100 may also provide an alarm message, without providing the user status information to the user electronic device. For example, when identifying that the user is drowsy based on the user status information, the electronic apparatus 100 may provide an alarm message to the user as a sound or vibrations without transmitting the user status information to the user electronic device.

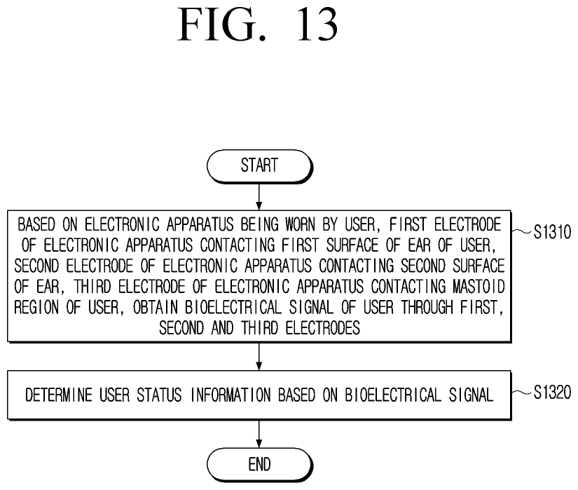

FIG. 13 is a flowchart illustrating an example method of controlling an electronic apparatus according to various embodiments.

In the example described hereafter, each of the operations may be performed sequentially, but not necessarily performed sequentially. For example, the order of each of the operations may be changed, and at least two of the operations may be performed in parallel.

According to an embodiment, it may be understood that S1310 to S1320 are performed by a processor (e.g., a processor 130 of FIG. 1 and/or FIG. 2) of an electronic apparatus (e.g., an electronic apparatus 100 of FIG. 1 and/or FIG. 2).

In the case where the first electrode of the electronic apparatus contacts the first surface of the ear of the user, the second electrode of the electronic apparatus contacts the second surface of the ear of the user, and the third electrode of the electronic apparatus contacts the mastoid region of the user as the electronic apparatus is worn by the user, a bioelectrical signal of the user is obtained via the first electrode, the second electrode, and the third electrode (S1310). Additionally, based on the bioelectrical signal, user status information is determined (S1320).

The obtaining a bioelectrical signal (S1310) may include obtaining at least one of EEG, EMG, EOG, EDA or GSR as a bioelectrical signal.

The obtaining a bioelectrical signal (S1310) may include obtaining a bioelectrical signal via the first electrode, the second electrode, and the third electrode in the case where it is identified that the electronic apparatus is worn by the user.

The obtaining a bioelectrical signal (S1310) may include obtaining skin impedance via at least two of the first electrode, the second electrode and the third electrode, and in the case where it is identified that the electronic apparatus is worn by the user based on the skin impedance, obtaining bioelectrical signal via the first electrode, the second electrode, and the third electrode.

The obtaining a bioelectrical signal (S1310) may include activating an audio function of the electronic apparatus, and obtaining a bioelectrical signal via the first electrode, the second electrode, and the third electrode, in the case where it is identified that the electronic apparatus is worn by the user based on the skin impedance.

The determining user status information (S1320) may include transmitting the bioelectrical signal to the user electronic device, and receiving user status information based on the bioelectrical signal from the user electronic device.

The user status information may include at least one of an attention level, a meditation level or a stress level, and a control method may further include providing a guide message to the user based on the user status information.

The determining user status information (S1320) may include obtaining motion data of the user and determining user status information based on the motion data and the bioelectrical signal.

The first electrode may be one of an active electrode and a reference electrode, the second electrode may be a ground electrode, and the third electrode may be the other of the active electrode and the reference electrode.

The first surface may include the front surface of the ear, and the second surface may include the rear surface of the ear.

The electronic apparatus is implemented, for example, in an ear clip form, as described above, and may have less volume and may be more lightweight than conventional, and secure a more comfortable fit than conventional. The first housing part and the second housing part may be formed in the way that the first housing part and the second housing part surround the ear of the user, and as proper pressure is applied based on the elasticity of the connecting element, the EEG measurement performance of the electronic apparatus may improve further than conventional.

Determining user status information based on a passive operation of the electronic apparatus is described above, but not limited thereto. For example, the electronica apparatus may also have the user listen to a sound that is repeated at a certain frequency or with a certain amplitude, and based on this, record an electrical response of the brain and measure a hearing ability.

As described above, a wearable electronic apparatus according to an embodiment may be worn on an ear of the user, and include: a housing including a first housing and a second housing connected to the first housing, memory storing instructions, a first electrode disposed at the first housing and configured to contact a first surface of the ear, a second electrode disposed at the second housing and configured to contact a second surface of the ear, a third electrode disposed at the second housing and configured to contact a mastoid region of the user, and at least one processor, comprising processing circuitry, wherein at least one processor, individually or collectively, may be configured to execute the instructions and to cause the wearable electronic apparatus to: obtain a bioelectrical signal of the user via the first electrode of the first housing, which contacts the first surface of the ear of the user, the second electrode of the second housing, which contacts the second surface of the ear of the user, and the third electrode of the second housing, which contacts the mastoid region of the user, while the wearable electronic apparatus is worn by the user.

In an example, the housing may include the first housing and the second housing and further include a connecting element comprising a connector having elasticity such that the first housing part and the second housing part may be apply a force on each housing part toward each other.

In an example, the wearable electronic apparatus may be formed in the way that the wearable electronic apparatus is worn by the user as the connecting element is folded, and a point at which the connecting element is folded maybe adjusted.

In an example, a length from the point at which the connecting element is folded to the first housing part may be greater than a length from the point at which the connecting element is folded to the second housing part.

In an example, the second housing part may include a first surface facing the second surface of the ear, a second surface disposed opposite to the first surface, and a side surface connecting the first surface and the second surface, and a portion of the third electrode may be disposed on the side surface.

In an example, an area of the side surface, in which the third electrode is disposed, may be curved to have a different curvature from an area of the side surface, in which the third electrode is not disposed.

In an example, a remainder of the third electrode except for the portion may be disposed on the first surface or the second surface.

In an example, the second housing part may have a greater volume than the first housing.

In an example, at least one processor, individually or collectively, may be configured to cause the wearable electronic apparatus to obtain at least one of EEG, EMG, EOG, EDA or GSR as the bioelectrical signal.

In an example, at least one processor, individually or collectively, may be configured to cause the wearable electronic apparatus to obtain at least one of the EDA or the GSR as the bioelectrical signal by applying a specified voltage to the third electrode, or obtain at least one of the EEG, EMG or EOG as the bioelectrical signal without applying the preset voltage to the third electrode.

In an example, the wearable electronic apparatus may further include a sensor, and at least one processor, individually or collectively, may be configured to cause the wearable electronic apparatus to obtain the bioelectrical signal via the first electrode, the second electrode and the third electrode based on identifying that the wearable electronic apparatus is worn by the user through the sensor.

In an example, at least one processor, individually or collectively, may be configured to cause the wearable electronic apparatus to: obtain skin impedance via at least two electrodes among the first electrode, the second electrode and the third electrode, and obtain the bioelectrical signal via the first electrode, the second electrode and the third electrode based on identifying that the wearable electronic apparatus is worn by the user based on the skin impedance.

In an example, at least one processor, individually or collectively, may be configured to cause the wearable electronic apparatus to: activate an audio function of the wearable electronic apparatus, and obtain the bioelectrical signal via the first electrode, the second electrode, and the third electrode based on identifying that the wearable electronic apparatus is worn by the user based on the skin impedance.

In an example, the wearable electronic apparatus may further include a communication interface comprising communication circuitry, and at least one processor, individually or collectively, may be configured to cause the wearable electronic apparatus to: control the communication interface to transmit the bioelectrical signal to a user electronic device, and receive a guide message corresponding to the bioelectrical signal from the user electronic device through the communication interface.

In an example, the wearable electronic apparatus may further include a sensor, and at least one processor, individually or collectively, may be configured to cause the wearable electronic apparatus to: obtain motion data of the user through the sensor, and provide a notification to the user based on the motion data.

In an example, the first electrode may be one of an active electrode and a reference electrode, the second electrode may be a ground electrode, and the third electrode may be the other of the active electrode and the reference electrode.

In an example, the first surface may include a front surface of the ear, and the second surface may include a rear surface of the ear.

As described above, a wearable apparatus according to an embodiment may include a housing, a first electrode disposed at the housing such that the first electrode may contact the concha of the user based on the wearable apparatus being worn by the user, a second electrode disposed at the housing such that the second electrode may contact a portion of an ear of the user based on the wearable apparatus being worn by the user, a third electrode disposed at the housing such that the third electrode may contact the mastoid (mastoid process) of the user based on the wearable apparatus being worn by the user, and at least one processor, comprising processing circuitry, accommodated in the housing and individually and/or collectively, configured to cause the wearable apparatus to obtain a bioelectrical signal of the user via the first, second and third electrodes.

In an example, the first electrode may include one of an active electrode and a reference electrode, the second electrode may include a ground electrode, and the third electrode may include the other of the active electrode and the reference electrode.

In an example, the housing may include a first housing accommodating the first electrode, a second housing accommodating the third electrode, and a connecting element comprising a connector connecting the first housing and the second housing.

In an example, the connecting element may be configured to provide an elastic force such that the elastic force is applied in a direction of first housing part and the second housing part toward each other.

In an example, the second electrode may be accommodated in the second housing, and disposed in the way that the second electrode contacts the rear surface of the ear based on the wearable apparatus being worn by the user.

In an example, the second housing may include a first surface facing the rear surface of the ear, a second surface opposite to the first surface, and a side surface connecting the first surface and the second surface, and at least a portion of the third electrode may be disposed in one area of the side surface.

In an example, the area of the side surface may be at least partially curved to have a different curvature from another area of the side surface.

In an example, another portion of the third electrode may extend up to the first surface or the second surface.

In an example, a size of the second housing may be greater than a size of the first housing.

In an example, based on the wearable apparatus being worn by the user, the connecting element may be configured to have a first connecting portion extending up to the first housing part from a central portion of the fold along the front surface of the ear, and a second connecting portion extending up to the second housing part from the central portion of the fold along the rear surface of the ear, and a length of the second connecting portion may be less than a length of the first connecting portion.

In an example, the connecting element may be configured such that that a position of the central portion of the fold is adjustable.

In an example, the bioelectrical signal may include at least one of EEG, EMG, or EOG.

In an example, at least one processor, individually and/or collectively, may be configured to obtain another bioelectrical signal using the first and third electrodes, while the processor does not obtain the bioelectrical signal.

In an example, the another bioelectrical signal may include EDA or GSR.

In an example, the wearable apparatus may further include a proximity sensor accommodated in the housing, and at least one processor, individually and/or collectively, may be configured to cause the wearable apparatus to determine whether the wearable apparatus is worn by the user using the proximity sensor.

In an example, at least one processor, individually and/or collectively, may be configured to cause the wearable apparatus to determine whether the wearable apparatus is worn by the user based on skin impedance measured via at least two electrodes among the first, second and third electrodes.

In an example, at least one processor, individually and/or collectively, may be configured to cause the wearable apparatus to: determine a first wearing state of the user based at least in part on the skin impedance measured via at least two electrodes among the first, second and third electrodes, activate a first function of the wearable apparatus based on determining that the wearable apparatus is not worn by the user based at least in part on the first wearing state, and activate the first function and a second function of the wearable apparatus based on determining that the wearable apparatus is not worn by the user based at least in part on the first wearing state.

In an example, the wearable apparatus may further include a proximity sensor accommodated in the housing, and at least one processor, individually and/or collectively, may be configured to cause the wearable apparatus to: determine a second wearing state of the user using the proximity sensor, and perform the determining the first wearing state based at least in part on the skin impedance based on determining that the wearable apparatus is worn by the user based at least in part on the second wearing state.

In an example, at least one processor, individually and/or collectively, may be configured to execute a function in association with an audio as at least part of the first function, and execute a function in association with the bioelectrical signal as at least part of the second function.

In an example, a contact surface of the first electrode may include a convex surface that is convex toward the concha.

In an example, the wearable apparatus may further include wireless communication circuitry configured to assist with short-range wireless communication between an external apparatus and the wearable apparatus, and at least one processor, individually and/or collectively, may be configured to cause the wearable apparatus to: transmit information in association with the bioelectrical signal to the external apparatus using the wireless communication circuitry such that the external apparatus may determine at least one of an attention level, a meditation level or a stress level based at least in part on the bioelectrical signal.

In an example, the external apparatus may be configured to generate a mindfulness score based at least in part on the at least one of an attention level, a meditation level or a stress level, generate advice information on the user based at least in part on the mindfulness score, and display the mindfulness score and the advice information as associated with each other through a display of the external apparatus.

In an example, the wearable apparatus may further include a motion sensor configured to sense a motion of the user, and at least one processor, individually and/or collectively, may be configured to cause the wearable apparatus to: obtain information on EEG while the user blinks or closes his or her eyes using the motion sensor and the bioelectrical sensor, determine whether the user is drowsy based at least in part on the information on EEG, and based on determining that the user is drowsy, notify the drowsiness of the user through a speaker of the wearable apparatus or an external apparatus connected to the wearable apparatus.

The various example embodiments described above may be implemented with software including instructions stored in a storage medium readable by a machine (e.g., a computer). The machine, as a device capable of calling the stored instructions from the storage media and operating according to the called instructions, may include an electronic apparatus (e.g., electronic apparatus A) according to the various disclosed example embodiments. Based on instructions executed by a processor, the processor may perform functions corresponding to the instructions directly or using other elements under the control of the processor. The instructions may include a code generated or executed by a compiler or an interpreter. The machine-readable storage medium may be provided in the form of a non-transitory storage medium. Herein, the “non-transitory” storage medium may not include a signal and the storage medium is tangible, while the term does distinguish semi-permanent or temporary storage of data in the storage medium.

According to various example embodiments set forth herein, the method may be provided in a computer program product. The computer program product may be exchanged between a seller and a purchaser as a commodity. The computer program product may be distributed in the form of a machine-readable storage medium (e.g., compact disc read only memory (CD-ROM)) or distributed online through an application store (e.g., Play Store™). In the case of online distribution, at least a portion of the computer program product may be stored at least temporarily, or generated temporarily in a storage medium such as a manufacturer's server, a server of an application store, or memory of a relay server.

Various example embodiments described above may be implemented in a recording medium readable by a computer or a device similar to a computer using software, hardware or a combination thereof. In some cases, the various embodiments set forth herein may be implemented as a processor itself. In the case of software implementation, the various embodiments such as steps and functions set forth herein may be implemented as separate software. Each software may perform one or more functions and operations set forth herein.

Further, each of the elements (e.g., a module or a program) according to various embodiments described above may be comprised of a single entity or a plurality of entities, and some of the corresponding sub elements described above may be omitted, or another sub element may be further included in various embodiments. Alternatively or additionally, some of the elements (e.g., modules or programs) may be integrated into one entity to perform identical or similar functions performed by each corresponding element prior to integration. Operations performed by a module, a program, or another element, according to various embodiments, may be executed sequentially, in parallel, repetitively, or heuristically, or at least some of the operations may be executed in a different order, omitted, or may add a different operation.

While various example embodiments of the present disclosure are illustrated and described above, the disclosure is not limited to specific embodiments set forth herein, and certainly, various modifications thereof may be made by those skilled in the art to which the present disclosure pertains, without departing from the scope the disclosure, including the appended claims and their equivalents, and should not be understood as being separate from the technical spirit or scope of the disclosure.

What is claimed is:

1. A wearable electronic apparatus comprising:
a housing configured to be worn on an ear of a user, and including a first housing and a second housing connected to the first housing;
memory storing instructions;
a first electrode disposed at the first housing, and configured to contact a first surface of the ear;
a second electrode disposed at the second housing, and configured to contact a second surface of the ear;
a third electrode disposed at the second housing, and configured to contact a mastoid region of the user; and
at least one processor, comprising processing circuitry,
wherein at least one processor, individually or collectively, is configured to execute the instructions and to cause the wearable electronic apparatus to:
while the wearable electronic apparatus is worn by the user, obtain a bioelectrical signal of the user via the first electrode, the second electrode and the third electrode.

2. The wearable electronic apparatus of claim 1,
wherein the housing further includes a connecting element comprising a connector configured to connect the first housing and the second housing, and having an elasticity such that the first housing and the second housing are provided with a force toward each other.

3. The wearable electronic apparatus of claim 2,
wherein the wearable electronic apparatus is configured to be worn by the user based on the connecting element being folded, and
a point at which the connecting element is folded is adjustable.

4. The wearable electronic apparatus of claim 3,
wherein a length from the point at which the connecting element is folded to the first housing is greater than a length from the point at which the connecting element is folded to the second housing.

5. The wearable electronic apparatus of claim 1, the second housing comprising:
a first surface facing the second surface of the ear;
a second surface disposed opposite to the first surface; and
a side surface connecting the first surface and the second surface,
wherein a portion of the third electrode is disposed on the side surface.

6. The wearable electronic apparatus of claim 5, wherein an area of the side surface, in which the third electrode is disposed, is curved to have a different curvature from an area of the side surface, in which the third electrode is not disposed.

7. The wearable electronic apparatus of claim 5, wherein a remainder of the third electrode is disposed on the first surface or the second surface.

8. The wearable electronic apparatus of claim 1, wherein the second housing has a greater volume than the first housing.

9. The wearable electronic apparatus of claim 1, wherein at least one processor, individually or collectively, is configured to cause the wearable electronic apparatus to:
obtain at least one of electroencephalogram (EEG), electromyogram (EMG), electrooculogram (EOG), electrodermal activity (EDA) or galvanic skin response (GSR) as the bioelectrical signal.

10. The wearable electronic apparatus of claim 9, wherein at least one processor, individually or collectively, is configured to cause the wearable electronic apparatus to:
obtain at least one of the EDA or the GSR as the bioelectrical signal by applying a specified voltage to the third electrode, or obtain at least one of the EEG, the EMG or the EOG as the bioelectrical signal without applying the specified voltage to the third electrode.

11. The wearable electronic apparatus of claim 1 further comprising:
a sensor,
wherein at least one processor, individually or collectively, is configured to cause the wearable electronic apparatus to:
based on identifying that the wearable electronic apparatus is worn by the user through the sensor, obtain the bioelectrical signal via the first electrode, the second electrode, and the third electrode.

12. The wearable electronic apparatus of claim 1, wherein at least one processor, individually or collectively, is configured to cause the wearable electronic apparatus to:
obtain skin impedance via at least two electrodes among the first electrode, the second electrode, and the third electrode; and
based on identifying that the wearable electronic apparatus is worn by the user based on the skin impedance, obtain the bioelectrical signal via the first electrode, the second electrode, and the third electrode.

13. The wearable electronic apparatus of claim 12,
wherein at least one processor, individually or collectively, is configured to cause the wearable electronic apparatus to:
based on identifying that the wearable electronic apparatus is worn by the user based on the skin impedance, activate an audio function of the wearable electronic apparatus, and obtain the bioelectrical signal via the first electrode, the second electrode, and the third electrode.

14. The wearable electronic apparatus of claim 1, further comprising:
a communication interface comprising communication circuitry,
wherein at least one processor, individually or collectively, is configured to cause the wearable electronic apparatus to:
control the communication interface to transmit the bioelectrical signal to a user electronic device; and
receive a guide message corresponding to the bioelectrical signal from the user electronic device through the communication interface.

15. The wearable electronic apparatus of claim 1, further comprising:
a sensor,
wherein at least one processor, individually or collectively, is configured to cause the wearable electronic apparatus to:
obtain motion data of the user through the sensor; and
provide a notification to the user based on the motion data.
